(19) United States
(12) Patent Application Publication
(10) Pub. No.: US 2023/0356015 A1
(43) Pub. Date: Nov. 9, 2023

(54) FIRE SUPPRESSANT SYSTEM

(71) Applicant: Square Head Inc., Kendrick, ID (US)

(72) Inventor: Robert Paul Groth, Kendrick, ID (US)

(73) Assignee: Square Head Inc., Kendrick, ID (US)

(21) Appl. No.: 17/737,792

(22) Filed: May 5, 2022

(51) Int. Cl. A62C 3/02

(52) U.S. Cl. CPC A62C 3/0257; A62C 3/0214

(57) ABSTRACT

A fire suppression system may include a fire resistant substrate. The fire resistant substrate may include a rectangular center portion, at least one appendage coupled to the rectangular center portion, and a tether system to couple the fire resistant substrate to a conveyance device. The tether system may include a cable, and a coupling device coupling the cable to the fire resistant substrate.

### TECHNICAL FIELD

The present disclosure relates generally to fire suppression systems. Specifically, the present disclosure relates to a fire resistant or fireproof substrate coupled to a tether system that allows the fire resistant or fireproof substrate to be deployed by a machine over structures, vegetation or other objects that are on fire in order to extinguish, control, or in some cases, entirely prevent fires from spreading or occurring.

### BACKGROUND

Uncontrolled fire has been a threat to life and property since time immemorial. Of the over 1,291,500 fires in the U.S. in 2019, 3,704 lives were lost with 16,600 injuries accounting for a 24.1% increase from 2010. These fires also accounted for $14.8 billion in damages accounting for a 74.5% increase from 2010. Further, it has been estimated that 354, 400 residential building fires occurred in 2019 that were caused by cooking-related activities (50.2%), heating (9.3%), general carelessness (7.7%), and electrical malfunctions (6.8%), among other causes. Of these residential fires, 1,900 individuals were killed. Residential fires are the leading property type for fire deaths (72.2%), fire injuries (76.4%) and fire dollar loss (46.4%). Many of those killed or injured in fires include first responders such as firefighters and police forces with approximately 102 firefighters dying on duty and 23, 825 firefighters being injured.

It is clear that even with current fire suppression systems and methods, fire continues to be a significant threat to life and property. For example, despite systems such as fire alarms, water sprinkling systems, foam dispersion systems, fire extinguishers, as well as the estimated over 29,705 fire departments, and over 1,115,000 firefighters in the United States, fire continues to be extremely deadly and injurious. Therefore, systems and methods that are capable of quickly and safely extinguishing uncontrolled fire while minimizing additional risk to first responders, residents, and other individuals is greatly needed.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a fire suppression system (FSS), according to an example of the principles described herein.

FIG. 2 illustrates an FSS, according to an example of the principles described herein.

FIG. 3 illustrates a detail of portion A of FIG. 2, according to an example of the principles described herein.

FIG. 4 illustrates a detail of portion B of FIG. 2, according to an example of the principles described herein.

FIG. 5 illustrates a detail of portion B of FIG. 2, according to an example of the principles described herein.

FIG. 6 illustrates a fire resistant substrate of the FSS of FIG. 1, according to an example of the principles described herein.

FIG. 7 illustrates a fire resistant substrate of the FSS of FIGS. 1 and/or 2, according to an example of the principles described herein.

FIG. 8 illustrates a fire resistant substrate of the FSS of FIGS. 1 and/or 2 in a folded state, according to an example of the principles described herein.

FIG. 9 illustrates a fire resistant substrate of the FSS of FIGS. 1 and/or 2 in a folded state and coupled to tether cables, according to an example of the principles described herein.

FIG. 10 illustrates a method of deploying the FSS of FIG. 1, according to an example of the principles described herein.

FIG. 11 illustrates a winch system associated with the FSS of FIG. 2, according to an example of the principles described herein.

FIG. 12 illustrates a method of deploying the FSS of FIG. 1, according to an example of the principles described herein.

### DESCRIPTION OF EXAMPLE EMBODIMENTS

The examples described herein provide a fire suppression system (FSS) including a conveyable fire resistant substrate. The fire resistant substrate may be used to safely extinguish objects on fire without requiring an individual to get close to the objects. The fire resistant substrate may be lifted above the object on fire using a conveyance device such as a helicopter or crane and set or placed onto the object on fire. The fire resistant substrate, once deployed, restricts the flow of oxygen or air into the presence of the object on fire, begins to cause the fire to consume all remaining oxygen under the fire resistant substrate, and extinguishes the fire.

As mentioned above, there are significant risks of death and serious injury to those involved in an uncontrolled fire. Further, destruction of property is a substantial issue that must also be addressed. In firefighting operations, it may be common to fight a structure fire by cutting a number of holes in the roof of the structure to allow for water to be sprayed into the in an attempt to extinguish the fire. Further, in order to rescue individuals from the structure, doors and windows may be broken or otherwise opened. However, cutting holes in the structure and opening doors and windows of the structure provide more oxygen to the fire and may exasperate the intensity of the fire resulting in more destruction. Further, water used to extinguish the fire may spread throughout a relatively larger portion of the structure resulting in an increase in damage to the structure.

If the fire to the structure were extinguished quickly, injury, death, smoke damage, fire damage, water damage and total structure loss may be reduced. This would lead to a decrease in loss of life and injury to individuals and may also reduce costs to rebuild and repair the structure. Further, if the fire were extinguished quickly, the duration of displacement of individuals from the structure such as homeowners, renters, and other individuals may be drastically reduced.

Still further, the ability to quickly extinguish the fire may decrease insurance premium costs to the owner of the structure since the risk of total loss is greatly decreased. Likewise, the ability to quickly extinguish the fire will decrease insurance payout costs by insurance providers since costs associated with the repair or rebuilding of the structure is significantly reduced. In fact, in some situations, an insurance company may experience such a reduction in claims and an overall savings within their company that the insurance company may invest in the firefighting groups and their activities including the creation of specialists who utilize the present systems and methods. This may include pilots and crane operators as described herein as well as investments in equipment including, for example, helicopters and cranes to deploy the present systems and methods.

Wildfires are also a significant threat to life and property as well as the beauty and sustainability of wilderness and grassland areas. The present systems and methods may be used to extinguish small, isolated wildfires. Further, larger wildfires may be extinguished using the present systems and methods by deploying the present system a number of times to extinguish the fire and allow other firefighters to extinguish remaining portions of the wildfire. Thus, the present systems and methods may be used to mitigate fire damage to wilderness areas as well as keep buildings and individuals including bystanders and firefighting personnel in the fire's path relatively out of danger.

Rural areas may experience a number of wildfires within a wildfire season. Some of these wildfires may be extremely devastating. To mitigate damages, even private individuals and companies that own water trucks and heavy equipment may be paid to remain on standby to assist local, county, state, and federal agencies when a wildfire starts. The present systems and methods may provide savings to private individuals and these government entities since fewer of these groups are needed to extinguish fires due to the advent of the present systems and methods.

### Overview

In the examples described herein, a fire suppressant that utilizes the idea of removing oxygen from the presence of the fire that is otherwise used to sustain combustion of the combustible material or fuel (e.g., wood, fabrics, grasses, etc.). Fire is the rapid oxidation of the combustible material in the exothermic chemical process of combustion, releasing heat, light, and various reaction products based on the type of combustible material. Fire is hot because the conversion of the weak double bond in molecular oxygen, O₂, to the stronger bonds in the combustion products carbon dioxide and water releases energy (e.g., approximately 418 kJ per 32 g of O₂). These bond energies of the combustible material play a relatively minor role during the conversion process. At a certain point in the combustion reaction, called the ignition point, flames are produced. The flame is the visible portion of the fire. Flames consist primarily of carbon dioxide, water vapor, oxygen, and nitrogen.

Removal of O₂ from the presence of the fire will significantly reduce the exothermic chemical reaction and extinguish the fire. Some fire suppressant devices and processes utilize the removal of O₂ such as, for example, dry chemical extinguishers that utilize nitrogen, water and foam extinguishers dispersed using compressed air, compressed carbon dioxide, dry chemical, dry powder, water, wetting agents, foams, and combinations thereof. However, use of these types of extinguishing systems may place the user in the same location as the fire and expose those individuals to the fire resulting in injury or death. The descriptions provide relatively safer fire extinguishing systems and methods.

Examples described herein provide a fire suppression system that may include a fire resistant substrate. The fire resistant substrate may include a rectangular center portion, at least one appendage coupled to the rectangular center portion, and a tether system to couple the fire resistant substrate to a conveyance device. The tether system may include a cable, and a coupling device coupling the cable to the fire resistant substrate.

The coupling device may include a servo-activated coupling device to, when activated, decouple the fire resistant substrate from the cable used to couple the fire resistant substrate to a conveyance device. The fire suppression system may further include at least a first grommet defined in the rectangular center portion, and at least a second grommet defined in the at least one appendage coupled to the rectangular center portion. At least a portion of the cable may be extended through at least one of the at least first grommet and the second grommet. The extension of the at least the portion of the cable through the at least one of the at least first grommet and the second grommet causes the fire resistant substrate to fold into a relatively smaller size. Removal of the at least the portion of the cable from at least one of the at least first grommet and the second grommet causes the fire resistant substrate to unfurl from a folded state.

The coupling device may include a cargo hook to, when activated releases the cable, causes the cable to move out of engagement with the at least one of the at least first grommet and the second grommet, and causes the fire resistant substrate to unfurl from the folded state. The cargo hook may be coupled to at least one of a helicopter and a crane. The fire resistant substrate may include at least one of an outer shell, a moisture barrier, a thermal battier, a number of air-filled dead zones, fiber glasses, asbestos, polymers, nylon, polyester, Nomex, Kevlar, batten, or combinations thereof. The cable may include at least one of fiber glasses, asbestos, polymers, nylon, polyester, Nomex, Kevlar, metal, metal alloys, or combinations thereof.

Examples described herein also provide a fire suppression device. The fire suppression device may include a fire resistant substrate. The fire resistant substrate may include a rectangular center portion and at least one appendage coupled to the rectangular center portion. The at least one appendage may extend from a side of the rectangular center portion. The fire resistant substrate may further include at least a first grommet defined in the rectangular center portion and at least a second grommet defined in the at least one appendage coupled to the rectangular center portion. The at least second grommet may align with the at least first grommet when the at least one appendage is folded over on top of the rectangular center portion.

The fire resistant substrate may include at least one layer of fire resistant material, and at least one cable incorporated into the at least one layer of fire resistant material to reinforce the at least one layer of fire resistant material. The fire resistant material may include at least one of an outer shell, a moisture barrier, a thermal battier, a number of air-filled dead zones, fiber glasses, asbestos, polymers, nylon, polyester, Nomex, Kevlar, batten, or combinations thereof.

The at least one appendage may include four appendages extending from four sides of the rectangular center portion, respectively. The at least first grommet may include a plurality of first grommets defined in the rectangular center portion. The second grommet may include a plurality of second grommets defined in the four appendages. The plurality of second grommets defined in the four appendages align with the plurality of first grommets defined in the rectangular center portion when the four appendages are folded over on top of the rectangular center portion, the alignment of the plurality of first grommets and the plurality of second grommets allowing for a cable to be extended therethrough. The fire suppression device may further include a tether system to couple the fire resistant substrate to a conveyance device. The tether system may include a cable, and a coupling device coupling the cable to the fire resistant substrate.

Examples described herein also provide a fire suppression system. The fire suppression system may include a fire resistant substrate. The fire resistant substrate may include a rectangular center portion, at least one appendage coupled to the rectangular center portion, and a tether system to couple the fire resistant substrate to a conveyance device. The tether system may include a cable. The fire suppression system may further include a coupling device coupling the cable to the fire resistant substrate, and a conveyance device. The fire suppression system may further include at least a first grommet defined in the rectangular center portion, and at least a second grommet defined in the at least one appendage coupled to the rectangular center portion. The at least second grommet aligns with the at least first grommet when the at least one appendage is folded over on top of the rectangular center portion. The conveyance system may include a crane or a helicopter.

The coupling device may include a servo-activated coupling device to, when activated, decouple the fire resistant substrate from the cable used to couple the fire resistant substrate to a conveyance device. At least a portion of the cable may be extended through at least one of the at least first grommet and the second grommet. The extension of the at least the portion of the cable through the at least one of the at least first grommet and the second grommet causes the fire resistant substrate to fold into a relatively smaller size. Removal of the at least the portion of the cable from at least one of the at least first grommet and the second grommet causes the fire resistant substrate to unfurl from a folded state. The coupling device may include a cargo hook to, when activated, release the cable, cause the cable to move out of engagement with the at least one of the at least first grommet and the second grommet, and cause the fire resistant substrate to unfurl from the folded state.

Additionally, the techniques described in this disclosure may be performed as a method and/or by a system having non-transitory computer-readable media storing computer-executable instructions that, when executed by one or more processors, performs the techniques described above.

### Example Embodiments

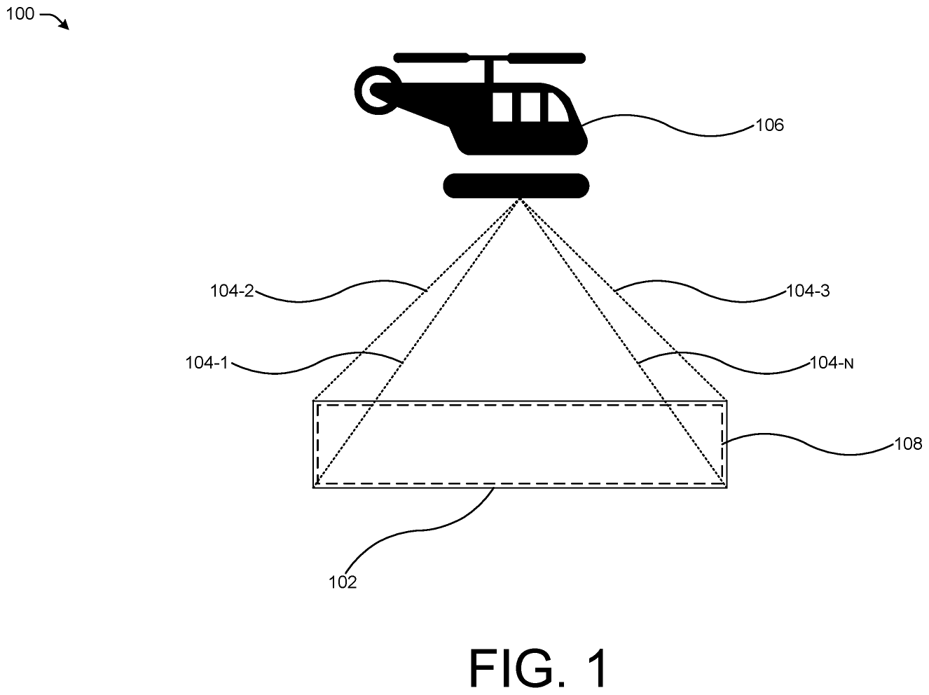

Turning now to the figures, FIG. 1 illustrates a fire suppression system (FSS) 100, according to an example of the principles described herein. The FSS 100 may include a fire resistant substrate 102. The fire resistant substrate 102 may include a generally rectangular-shape, but the fire resistant substrate 102 may include any shape and may include any number of appendages or flaps. The appendages may include any shape. The appendages are described herein in connection with other examples.

The fire resistant substrate 102 may include at least one layer of fire resistant material, and at least one integrated cable 108 incorporated into the at least one layer of fire resistant material to reinforce the at least one layer of fire resistant material. The fire resistant material may include at least one of an outer shell, a moisture barrier, a thermal battier, a number of air-filled dead zones, fiber glasses, asbestos, polymers, nylon, polyester, Nomex, Kevlar, batten, or combinations thereof. In one example, the moisture barrier may be eliminated in order to reduce weight since this layer is reserved for similar fabric constructions used in firefighter turnouts to protect the individual from burns from fire whereas deployment of the present fire resistant substrate 102 from a distance would not necessitate protect of individuals.

In one example, the fire resistant substrate 102 may be made of relatively flaccid, bendable material(s) such that the fire resistant substrate 102 may be folded or bent. Further, the fire resistant substrate 102 may be made of relatively flaccid, bendable material(s) such that the fire resistant substrate 102 may be placed over a surface of an object and allowed to generally follow the contours of the object. For example, in instances where the fire resistant substrate 102 is placed over a structure, the relatively flaccid, bendable material(s) allow for the fire resistant substrate 102 may drape over and generally follow roof contours, wall contours, and other features of the structure.

In one example, the fire resistant substrate 102 of the FSS 100 may be coupled to a number of tether cables 104-1, 104-2, 104-3, 104-N, where N is any integer greater than or equal to 1 (collectively referred to as “tether cables 104”). The tether cables 104 may be coupled to one or more portions of the fire resistant substrate 102 such as, for example, corners of the fire resistant substrate 102 as depicted in FIG. 1. The tether cables 104 may be made of, for example, fiber glasses, asbestos, polymers, nylon, polyester, Nomex, Kevlar, metal, metal alloys, and combinations thereof.

The tether cable 104 may couple the fire resistant substrate 102 to a conveyance device 106. The example of FIG. 1 depicts a helicopter. However, the conveyance device 106 may include any device or machine that is capable of carrying the fire resistant substrate 102 by the tether cables 104 and lifting the fire resistant substrate 102 over a structure, field of vegetation, an automobile, or other item that is on fire. Thus, the conveyance device 106 may include a helicopter, a plane, a crane, or a fire-fighting ladder truck, among other weight carrying devices.

The fire resistant substrate 102 may be sized to facilitate the extinguishing of relatively large objects such as the above-described structure, field of vegetation, an automobile, or other item that is on fire. In one example, the fire resistant substrate 102 may include a relatively rectangular shape with dimensions between 10 feet (ft) and 200 ft by between 10 ft and 200 ft. In one example, the fire resistant substrate 102 may include a relatively rectangular shape with dimensions of 30 ft by 60 ft, 30 ft by 100 ft, 80 ft by 160 ft, and other dimensions that may provide for coverage of the object(s) on fire. In one example, the fire resistant substrate 102 may include a central portion with a number of appendages extending from the central portion as described in examples herein.

By way of example, a ranch-style home may be the object on fire. In this example, the ranch-style home may be approximately 1,000 square (sq) ft to 2,000 sq ft. A fire resistant substrate 102 that is 80 ft by 160 ft or 12,800 sq ft could easily span this size of structure. The fire resistant substrate 102 may weigh approximately between 2 to 10 pounds (lbs.) per sq ft. Thus, this example fire resistant substrate 102 may weigh approximately between 12.8 tons and 64 tons. Thus, the conveyance device 106 may include a device that is capable of lifting this much weight. For example, where the conveyance device 106 is a helicopter, the helicopter may include a MIL V-12 developed and distributed by Mil Design Bureau, a MIL MI-26 developed and distributed by Mil Moscow Helicopter Plant, a MIL MI-6 developed and distributed by Mil Moscow Helicopter Plant, a CH-54 TARHE developed and distributed by Sikorsky Aircraft, and a CH-53E Super Stallion developed and distributed by Sikorsky Aircraft, among other aircraft. In one example, a plurality of helicopters may be used to convey the fire resistant substrate 102.

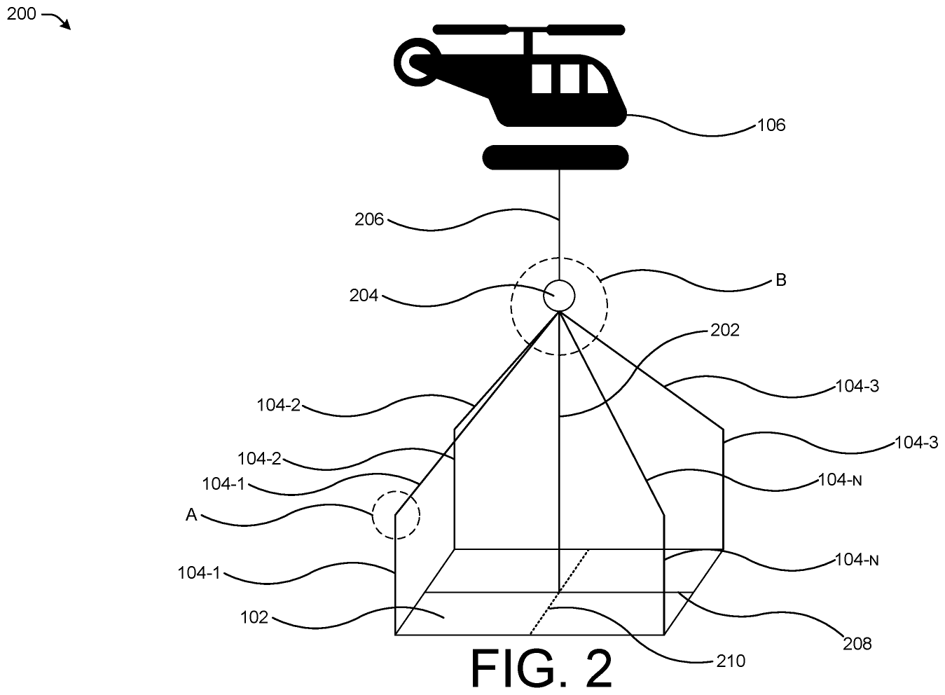

FIG. 2 illustrates an FSS 200, according to an example of the principles described herein. The example of FIG. 2 may include a fire resistant substrate 102 that is folded on itself as described herein. The folds 208, 210 are identified by lines drawn on the fire resistant substrate 102. In one example, the fire resistant substrate 102 may include a number of appendages as described herein. The appendages may be folded onto a center portion of the fire resistant substrate 102 in order to make the fire resistant substrate 102 more compact and relatively easier to move and deploy onto the object on fire.

In the example of FIG. 2, the tether cables 104 may be coupled to corners or edges of the fire resistant substrate 102, and a center cable 202 may be coupled to a center of the fire resistant substrate 102. The center cable 202 may serve to support the fire resistant substrate 102 during transport and deployment such that an operator of the conveyance device 106 may be able to more effectively and efficiently place the fire resistant substrate 102 on the object on fire. In this manner, the center cable 202 may stabilize the fire resistant substrate 102 when used in association with the tether cables 104.

The FSS 200 may be coupled to the conveyance device 106 via a coupling device 204 and/or a longline 206. In one example, the coupling device 204 may be coupled directly to the conveyance device 106 without any intermediate cabling. In this example, the load including the fire resistant substrate 102 carried by the conveyance device 106 may be relatively better targeted with relatively less lag in placement.

In contrast, in one example, the longline 206 may be coupled to the conveyance device 106 and the coupling device 204 may be coupled to the longline 206. In this example, the longline allows for the operator of the conveyance device 106 to better view the load including the fire resistant substrate 102 carried by the conveyance device 106 for placement purposes. Further, use of a longline 206 allows for the conveyance device 106 and the operator to remain at a relatively farther distance from the object on fire resulting in increased safety despite the lag in movement of the fire resistant substrate 102.

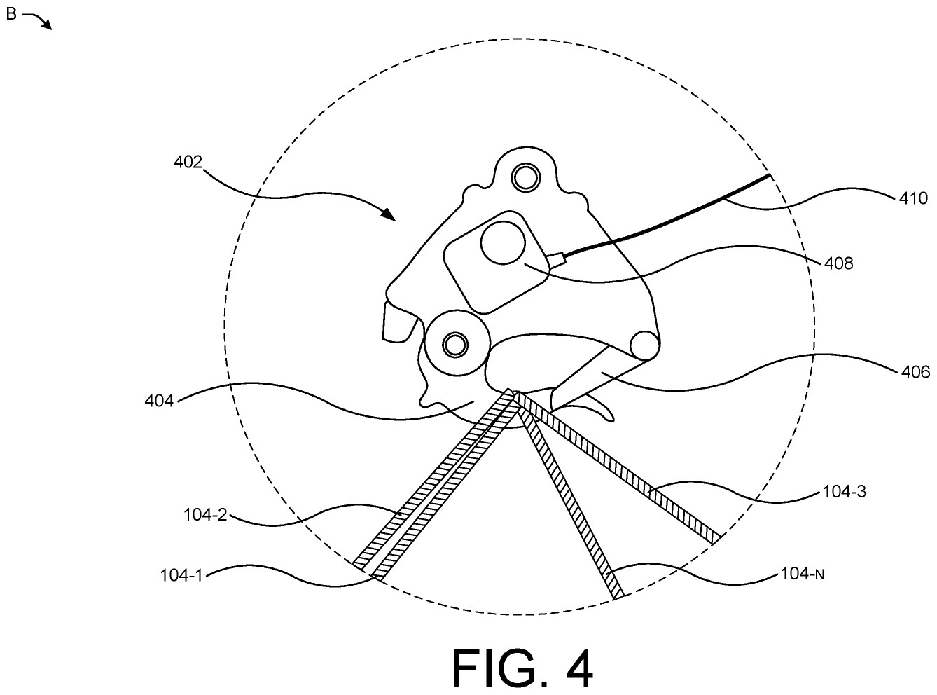

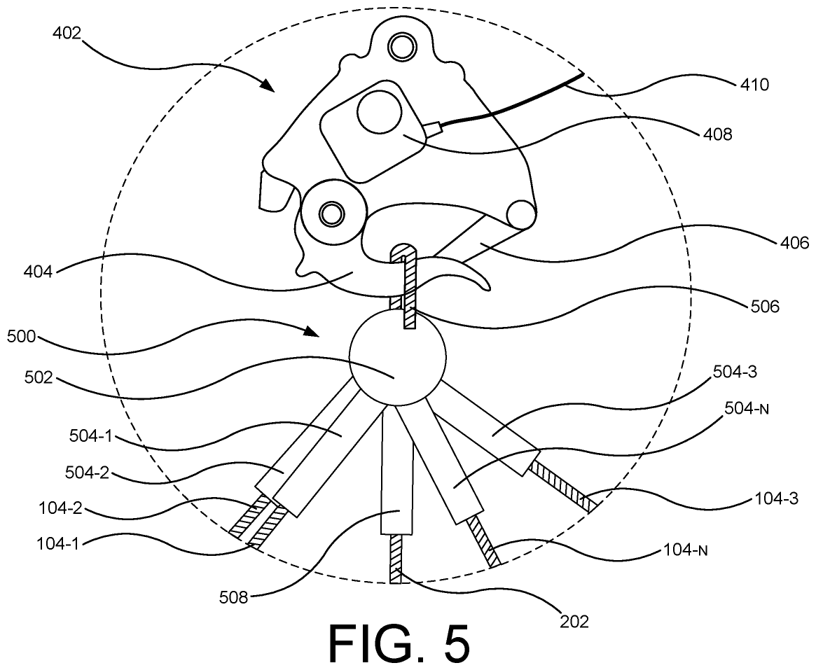

The longline 206 may include any material the tether cables are made of. The coupling device 204 may include a cargo hook, for example that may selectively couple the fire resistant substrate 102 to the conveyance device 106. In one example, the cargo hook may be selectively actuated to release the fire resistant substrate 102 from the conveyance device 106 by the operator of the conveyance device 106. More regarding the cargo hook is described herein in connection with FIGS. 4 and 5.

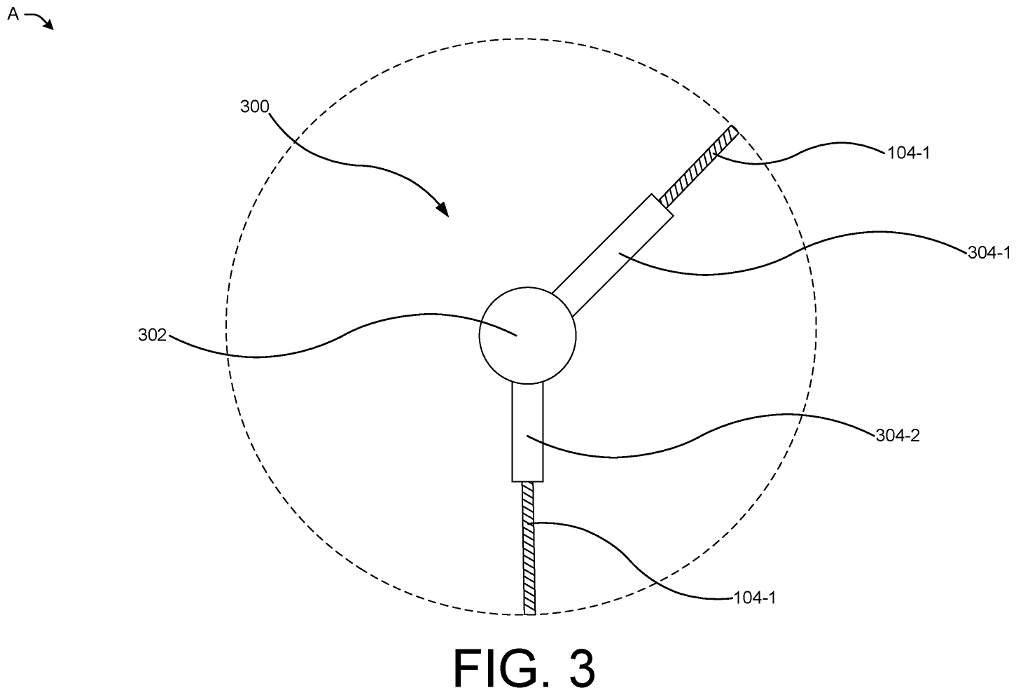

Turning now to FIG. 3, FIG. 3 illustrates a detail of portion A of FIG. 2, according to an example of the principles described herein. Detail A depicts an elbow 300 that may be used to keep the tether cables 104 lined up with the edges or corners of the fire resistant substrate 102. In one example, each of the tether cables 104 may include an elbow 300.

The elbows 300 may include a core portion 302 with a number of arms 304-1, 304-2. The tether cable 104 may be embedded within or otherwise coupled to the core portion 302 and/or the arms 304-1, 304-2. The elbows 300 serve to orient the tether cables 104 to their respective locations of the fire resistant substrate 102 at which the tether cables 104 are coupled.

FIG. 4 illustrates a detail of portion B of FIG. 2, according to an example of the principles described herein. In FIG. 4, the coupling device 204 is depicted being coupled to the tether cables 104. In one example, the coupling device 204 may include a cargo hook 402. The cargo hook 402 may include any device suspended below the conveyance device 106 and that allows the transport of external loads during operation of the conveyance device 106. For example, the cargo hook 402 may be coupled directly or indirectly to the underside of a helicopter, at an end of a cable of a crane, or at other load bearing portions of the conveyance device 106. The cargo hook 402 may be used in various operations including as sling work, as an underslung load, as an external load work operation, as external load operations, or similar operations. The cargo hook 402 may include a keeper 406 that includes a locking, spring-operated mechanism that keeps the load (e.g., the fire resistant substrate 102 and the tether cables 104, etc.) from sliding off a load beam 404 during transport. The keeper 406 may be activated to open and close based on the activation of a servo mechanism 408 mechanically coupled to the keeper 406 and electrically coupled to control devices associated with the conveyance device 106 via a wired or wireless interface. For example, a signal cable 410 may be coupled to a control interface within the conveyance device 106 such that when an operator of the conveyance device 106 selects the control interface associated with the signal cable 410 and the servo mechanism 408, the keeper 406 is selectively opened and closed. In this manner, the cargo hook 402 may be used to deploy the fire resistant substrate 102 onto an object on fire upon activation of the servo mechanism 408 and the releasing of the fire resistant substrate 102 from the load beam 404. In one example, the load beam 404 may also rotate about a pivot upon activation of the servo mechanism 408 to allow the tether cables 104 to fall from the load beam 404. As mentioned above, the servo mechanism 408 may be activate remotely using a radio transmitter.

FIG. 5 illustrates a detail of portion B of FIG. 2, according to an example of the principles described herein. In association with the elbows 300 of FIG. 3, a hub 500 that is used to arrange the tether cables 104 and reduce or eliminate the possibility of the tether cables 104 becoming entangled with one another. The hub 500 may include a core portion 502 with a number of arms 504-1, 504-2, 504-3, 504-N, where N is any integer greater than or equal to 1 (collectively referred to as “arms 504”). The tether cables 104 may each be coupled to a respective arm 504. Further, the hub 500 may include a center arm 508 coupled to the core portion 502 that couples the center cable 202 to the hub 500.

A coupling cable 506 may also be included with the core portion 502 to allow the hub 500 and the tether cables 104 to be coupled to the cargo hook 402. In one example, the tether cables 104 and the coupling cable 506 may be embedded within or otherwise coupled to the core portion 502, the arms 504, and/or the center arm 508. In FIGS. 4 and 5, the cargo hook 402 is depicted as not being coupled to the conveyance device 106 and/or the longline 206. However, as depicted in, for example, FIG. 2, the cargo hook 402 may be coupled to the conveyance device 106 and/or the longline 206 directly or indirectly in order to convey the fire resistant substrate 102 to a position where the fire resistant substrate 102 may be deployed and used to extinguish a fire. In one example, deployment of the fire resistant substrate 102 over an object on fire causes the oxygen utilized by the fire to be consumed under the fire resistant substrate 102 and resulting in the extinguishing of the fire. This may be true even in instances where the fire resistant substrate 102 does not cover an entirety of the object on fire.

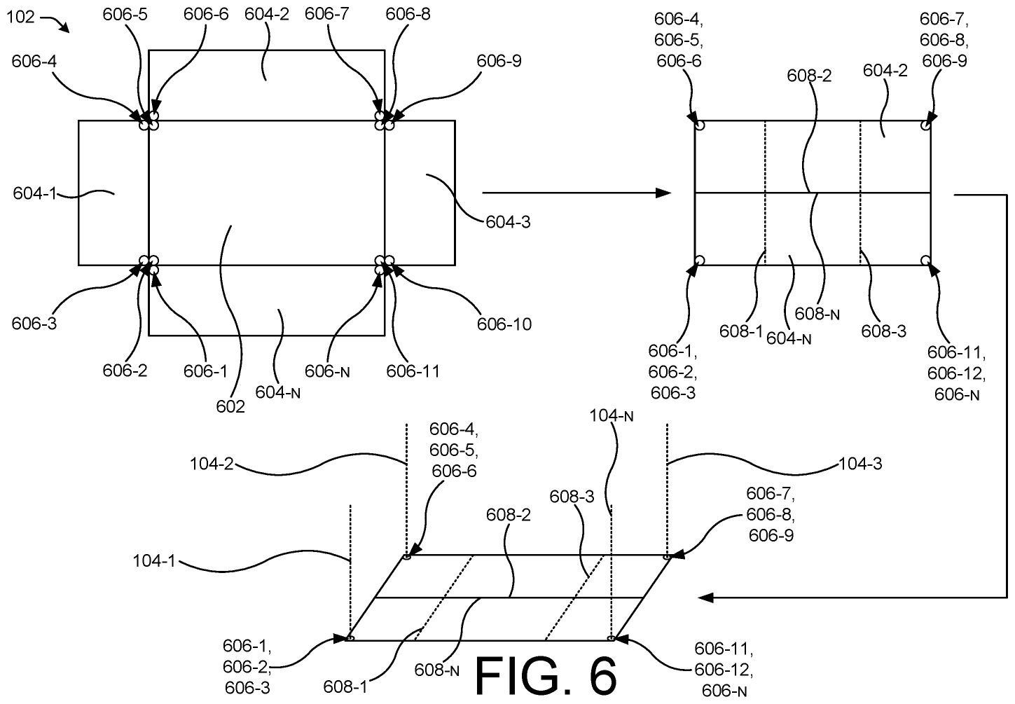

FIG. 6 illustrates the fire resistant substrate 102 of the FSS 100 of FIG. 1, according to an example of the principles described herein. FIG. 6 depicts progressive steps related to the folding of the fire resistant substrate 102 for storage, conveyance, and/or deployment purposes. As mentioned herein, the fire resistant substrate 102 may be folded or bent as a number of appendages are folded onto a center portion. Thus, in one example, the fire resistant substrate 102 may include a center portion 602 and a number of appendages 604-1, 604-2, 604-3, 604-N, where N is any integer greater than or equal to 1 (collectively referred to as “appendages 604”). The appendages 604 in FIG. 6 include a number of rectangular-shaped appendages that extend from the center portion 602. However, the appendages 604 may have any shape. In one example, the appendages 604 may be formed from the same material as the center portion 602. One example, the appendages 604 may be formed from a different material with respect to the center portion 602.

In one example, the appendages 604 may be monolithically formed with the center portion 602 such that the center portion 602 and the appendages 604 include a single piece of material or numbers of materials. In one example, the appendages 604 may be coupled to the center portion 602 as a number of separate pieces. In this example, the appendages 604 may be coupled to the center portion 602 via any coupling devices or means such as, for example, sewing, welding, via a number of fasteners, gluing using one or more adhesives, other coupling devices or means, and combinations thereof.

In one example, a number of grommets 606-1, 606-2, 606-3, 606-4, 606-5, 606-6, 606-7, 606-8, 606-9, 606-10, 606-11, 606-N, where N is any integer greater than or equal to 1 (collectively referred to as “grommets 606”). The grommets 606 may include apertures defined in the center portion 602 and/or appendages 604 with a ring or edge strip inserted into the apertures. The grommets 606 may be made of a metal, a plastic, a rubber, or combinations thereof. The grommets 606 serve to allow the tether cables 104 to be threaded through the grommets 606 and support the fire resistant substrate 102 during conveyance of the fire resistant substrate 102 and deployment of the fire resistant substrate 102 to cover the object on fire as described in more detail herein.

The appendages 604 may be folded over the top of the center portion 602 as depicted in the transition from the upper left image to the upper right image of the fire resistant substrate 102 depicted in FIG. 6. In one example, the grommets 606 formed in the center portion 602 and the appendages 604 may align such that the tether cables 104 may extend through a number of apertures simultaneously. For example, grommets 606-1, 606-2, and 606-3 are defined in appendage 604-N, the center portion 602, and appendage 604-1, respectively. Similarly, grommets 606-4, 606-5, and 606-6 are defined in appendage 604-1, the center portion 602, and appendage 604-2, respectively. Grommets 606-7, 606-8, and 606-9 are defined in appendage 604-2, the center portion 602, and appendage 604-3, respectively. Further, grommets 606-10, 606-11, and 606-N are defined in appendage 604-3, the center portion 602, and appendage 604-N, respectively.

In the example of FIG. 6, appendages 604-1 and 604-3 are folded onto the center portion 602 and dashed lines 608-1 and 608-3 indicate the edges of appendages 604-1 and 604-3 being disposed beneath appendages 604-2 and 604-N. Further, appendages 604-2 and 604-N may be folded onto appendages 604-1 and 604-3 and the center portion 602 with lines 608-2 and 608-N indicating the edges of appendages 604-2 and 604-N. In this manner, the fire resistant substrate 102 may be stored, conveyed, and deployed from a more compact state via the folding of the fire resistant substrate 102 in the manner described in connection with FIG. 6 or in other ways.

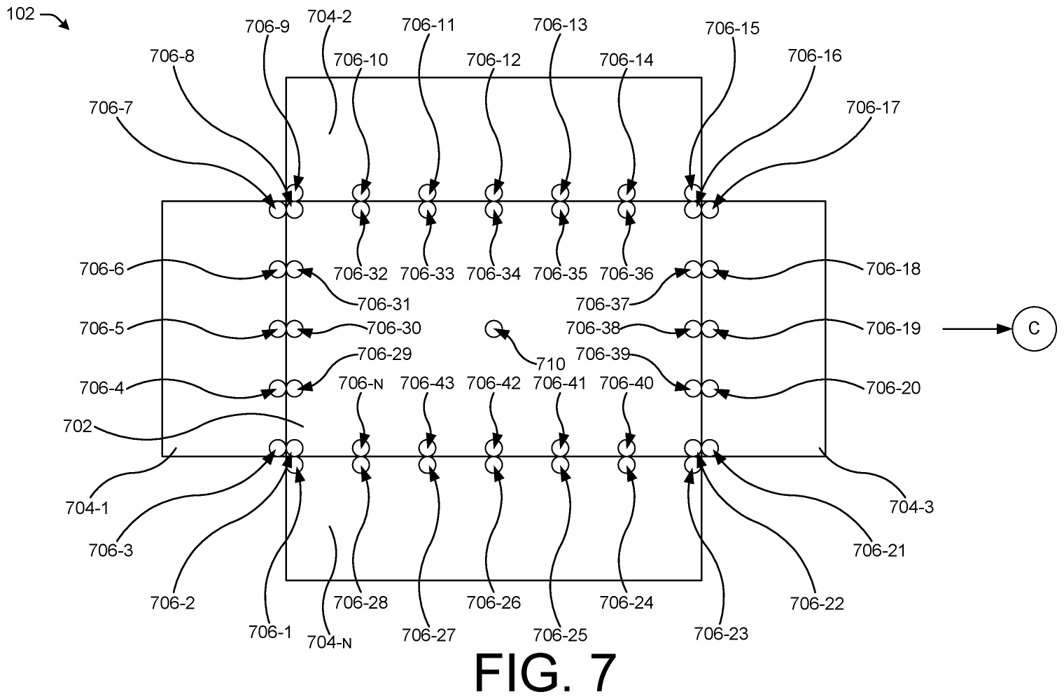

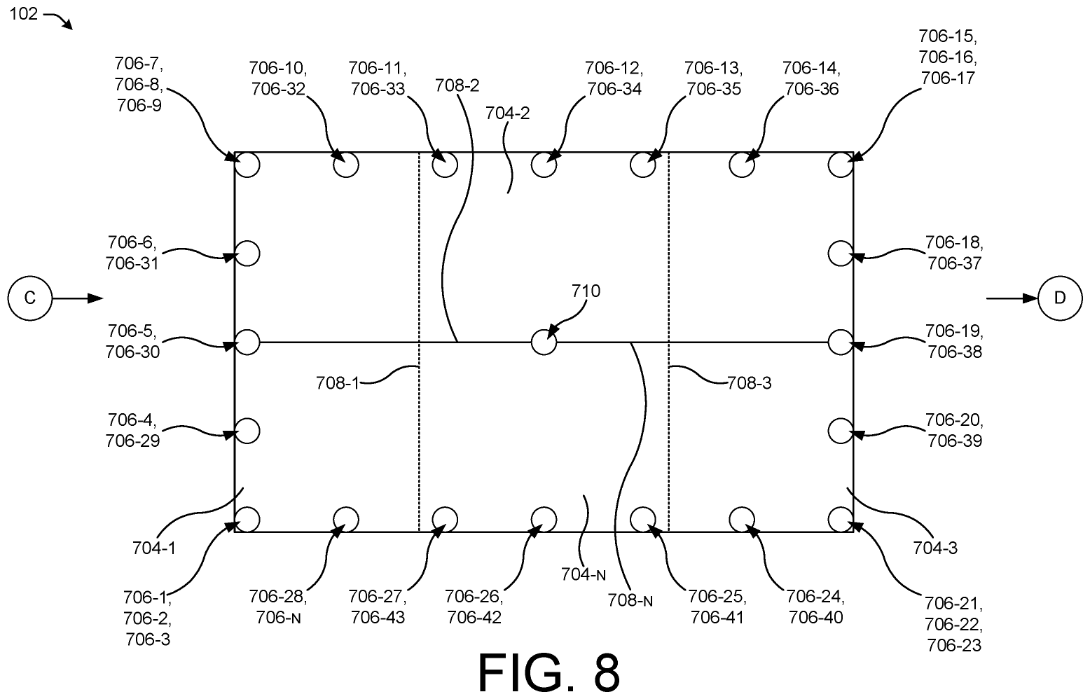

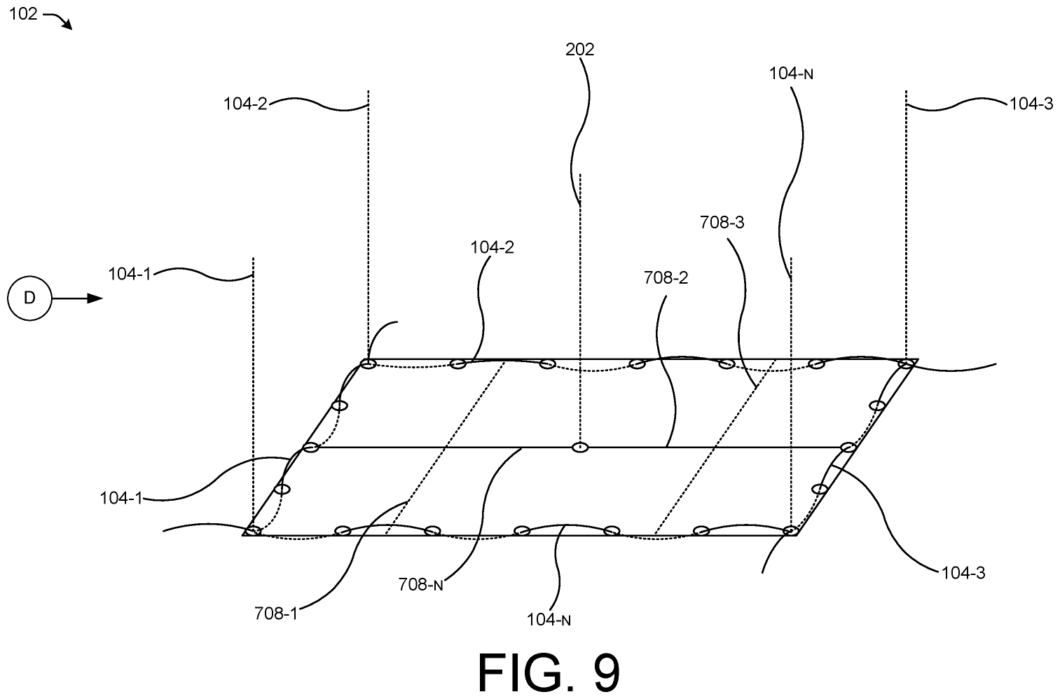

FIG. 7 illustrates the fire resistant substrate 102 of the FSS 100, 200 of FIGS. 1 and/or 2, according to an example of the principles described herein. FIG. 8 illustrates the fire resistant substrate 102 of the FSS 100, 200 of FIGS. 1 and/or 2 in a folded state, according to an example of the principles described herein. FIG. 9 illustrates the fire resistant substrate 102 of the FSS 100, 200 of FIGS. 1 and/or 2 in a folded state and coupled to tether cables, according to an example of the principles described herein. FIGS. 7-9 depict progressive steps related to the folding of the fire resistant substrate 102 for storage, conveyance, and/or deployment purposes with “C” of FIG. 7 directing to FIG. 8 and “D” directing to FIG. 9. As mentioned herein, the fire resistant substrate 102 may be folded or bent as a number of appendages are folded onto a center portion. Thus, in one example, the fire resistant substrate 102 may include a center portion 702 and a number of appendages 704-1, 704-2, 704-3, 704-N, where N is any integer greater than or equal to 1 (collectively referred to as “appendages 704”). The appendages 704 in FIGS. 7-9 include a number of rectangular-shaped appendages that extend from the center portion 702. However, the appendages 704 may have any shape. In one example, the appendages 704 may be formed from the same material as the center portion 702. One example, the appendages 704 may be formed from a different material with respect to the center portion 702.

In one example, the appendages 704 may be monolithically formed with the center portion 702 such that the center portion 702 and the appendages 704 include a single piece of material or numbers of materials. In one example, the appendages 704 may be coupled to the center portion 702 as a number of separate pieces. In this example, the appendages 704 may be coupled to the center portion 702 via any coupling devices or means such as, for example, sewing, welding, via a number of fasteners, gluing using one or more adhesives, other coupling devices or means, and combinations thereof.

Further, as described herein, the fire resistant substrate 102 may be folded to provide for an easy way to store, convey, and deploy the fire resistant substrate 102. Like the example of FIG. 6, the example of FIGS. 7-9 may include a number of grommets 706-1, 706-2, 706-3, 706-4, 706-5, 706-6, 706-7, 706-8, 706-9, 706-10, 706-11, 706-12, 706-13, 706-14, 706-15, 706-16, 706-17, 706-18, 706-19, 706-20, 706-21, 706-22, 706-23, 706-24, 706-25, 706-26, 706-27, 706-28, 706-29, 706-30, 706-31, 706-32, 706-33, 706-34, 706-35, 706-36, 706-37, 706-38, 706-39, 706-40, 706-41, 706-42, 706-43, 706-N, where N is any integer greater than or equal to 1 (collectively referred to as “grommets 706”). Further, a center grommet 710 may be included in the fire resistant substrate 102 to couple the center cable 202 to the fire resistant substrate 102. The grommets 706 may include apertures defined in the center portion 702 and/or appendages 704 with a ring or edge strip inserted into the apertures. The grommets 706 may be made of a metal, a plastic, a rubber, or combinations thereof. The grommets 706 serve to allow the tether cables 104 to be threaded through the grommets 706 and support the fire resistant substrate 102 during conveyance of the fire resistant substrate 102 and deployment of the fire resistant substrate 102 to cover the object on fire as described in more detail herein. Further, in one example, the fire resistant substrate 102 may be stored in the state depicted in FIG. 9, for example, so that the fire resistant substrate 102 is ready for deployment in case of an emergency (e.g., the instance of a fire).

The appendages 704 may be folded over the top of the center portion 702 as depicted in the transition from the upper left image to the upper right image of the fire resistant substrate 102 depicted in FIGS. 7-9. In one example, the grommets 706 formed in the center portion 702 and the appendages 704 may align such that the tether cables 104 may extend through a number of apertures simultaneously. For example, grommets 706-1, 706-2, and 706-3 are defined in appendage 704-N, the center portion 702, and appendage 704-1, respectively. Similarly, grommets 706-4 and 706-29 are defined in appendage 704-1 and the center portion 702, respectively. Grommets 706-5 and 706-30 are defined in appendage 704-1 and the center portion 702, respectively. This pairing of grommets 706 continues around the surface area of the various portions of the fire resistant substrate 102 as can be seen in the transition between an unfolded state depicted in FIG. 7 to a folded state depicted in FIGS. 8 and 9. The remainder of the pairings is described in detail here for brevity purposes. However, the pairings of grommets 706 are explicitly described and depicted in FIG. 8.

In the example of FIGS. 7-9, appendages 704-1 and 704-3 are folded onto the center portion 702 and dashed lines 708-1 and 708-3 indicate the edges of appendages 704-1 and 704-3 being disposed beneath appendages 704-2 and 704-N. Further, appendages 704-2 and 704-N may be folded onto appendages 704-1 and 704-3 and the center portion 702 with lines 708-2 and 708-N indicating the edges of appendages 704-2 and 704-N. In this manner, the fire resistant substrate 102 may be stored, conveyed, and deployed from a more compact state via the folding of the fire resistant substrate 102 in the manner described in connection with FIGS. 7-9 or in other ways.

In one example, the tether cables 104 may be used to cause the deployment of the appendages 704 away from the center portion 702 before or during the deployment of the overall fire resistant substrate 102 As depicted in FIG. 9, for example, the tether cables 104 may be inserted through a number of the grommets 706. In one example, the tether cables 104 may be inserted through a number of the grommets 706 in a weaving manner where the tether cables 104 are inserted into a first grommet 706 from a first side of the fire resistant substrate 102 and inserted into a second grommet 706 from the other, second side of the fire resistant substrate 102.

In one example, the tether cables 104 may be inserted into a first grommet 706 from a first side of the fire resistant substrate 102 and inserted into a second grommet 706 from the other, second side of the fire resistant substrate 102 where the second grommet 706 is neighboring the first grommet 706. In this manner, the tether cables 104 may be laced into the grommets 706.

In one example, the tether cables 104 may be each laced through a row of grommets 706 along a side of the fire resistant substrate 102 in order to facilitate deployment of the fire resistant substrate 102 over the object on fire. In one example, the tether cables 104 may be removed from the grommets 706 during deployment of the fire resistant substrate 102 to allow the appendages 704 to move freely with respect to the center portion 702 and unfurl to cover mode of the object that is on fire.

In one example, the tether cables 104 may be threaded into the grommets 706 via a chain sinnet, a chain stich, or similar stitch where, for an edge of the fire resistant substrate 102, a single tether cable 104 is used. In this example, the single tether cable 104 may be interlooped with itself on a first side of the edge of the fire resistant substrate 102. The chain sinnet, chain stitch, or similar stitch may be released by pulling an end of the tether cable 104 to allow the stitching to come undone and release the appendage 704 located on that edge of the fire resistant substrate 102 from the center portion 702. This may be repeated for every edge of the fire resistant substrate 102 and with each of the tether cables 104 to allow each of the appendages 704 to separate from the center portion 702 before or during deployment of the fire resistant substrate 102.

In one example, the tether cables 104 may be threaded into the grommets 706 via a chain sinnet, a chain stich, or similar stitch where, for tow edges of the fire resistant substrate 102, a pair of tether cables 104 may be used. In this example, a dual thread stich formed by a first tether cable 104 passing through the grommets 706 of the fire resistant substrate 102 may be interlooped with a second tether cable 104 along a first side of the edges of the fire resistant substrate 102. The chain sinnet, chain stitch, or similar stitch may be released by pulling an end of the first or second tether cable 104 to allow the stitching to come undone and release the appendages 704 located on the two edges of the fire resistant substrate 102 from the center portion 702. This may be repeated for every edge pair of the fire resistant substrate 102 and with each of the tether cables 104 to allow each of the appendages 704 to separate from the center portion 702 before or during deployment of the fire resistant substrate 102. In one example, more than four tether cables 104 may be included in the FSS 100 to provide for two pairs of tether cables 104 for each side. For example, eight tether cables 104 may be included to provide a pair of tether cables 104 for each edge of the fire resistant substrate 102.

The chain sinnet, chain stitch, or similar stitch as used herein may include, for example, any stich defined by the International Organization for Standardization (ISO) 4915:1991 textile stich type standards. For example, the chain sinnet, chain stitch, or similar stitch may include the ISO #101 chainstitch, an ISO #401 chainstitch, or an ISO #401 twin needle chainstitch, among a number of other types of stitching. As used in the present specification and in the appended claims, the term “stitch, “stitching,” or similar language is meant to be understood broadly as any interaction of one or more strands of material such as the tethering cables 104 to form a stitch or stitch-like series.

Although not depicted, the example of the fire resistant substrate 102 of FIG. 1 may also be folded for storage, conveyance, and/or deployment in a similar manner as described in connection with the example of FIGS. 2 and 6-9. Further, although not depicted, the example of the fire resistant substrate 102 of FIG. 1 may include grommets 606, 706 and/or may be stitched using the tether cables 104 in a similar manner as described herein in connection with FIGS. 6-9.

Turning again to FIGS. 6-9, in one example, the fire resistant substrate 102 may include four appendages 604, 704. The four appendages 604, 704 in the examples of FIGS. 6 and 7 and other examples described herein, may provide for the appendages 604, 704 of the fire resistant substrate 102 to drape over the sides of the object (e.g., a structure) and drop to the ground or at least relatively close to the ground. In this orientation with the center portion 602, 702 may cover the bulk of the object, and the four appendages 604, 704 may cover individual portions of the object to ensure that the most surface area of the object is covered. This would result in a more significant consumption of the oxygen within the structure and speed the extinguishing of the fire within the structure.

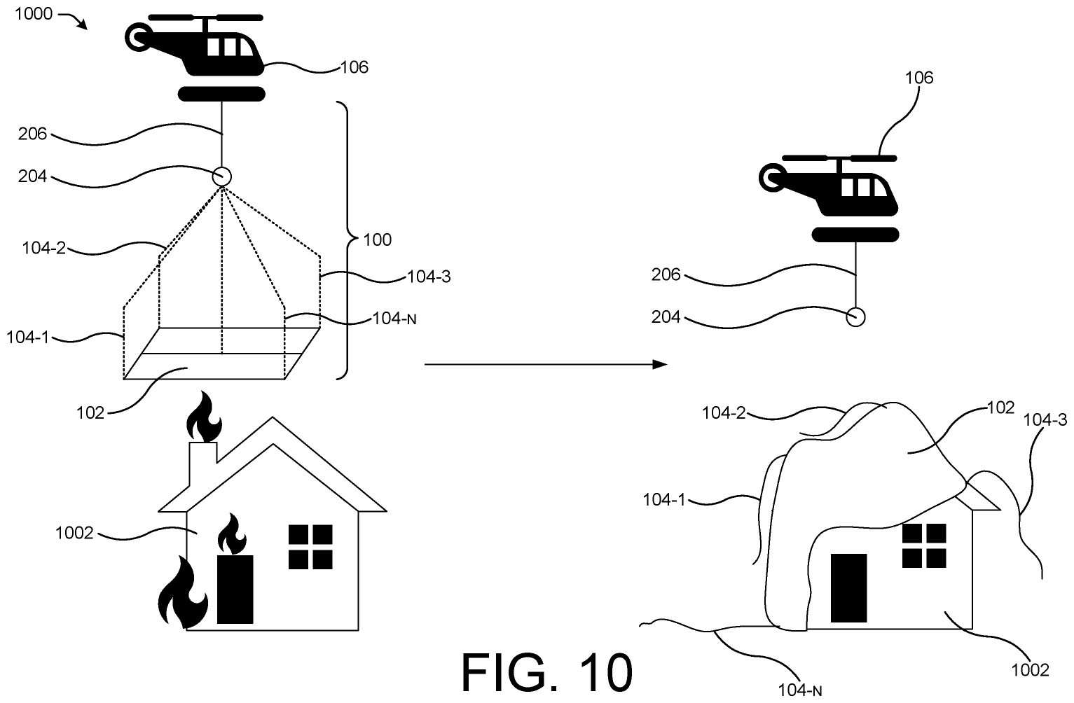

FIG. 10 illustrates a method 1000 of deploying the FSS 100 of FIG. 1, according to an example of the principles described herein. A mentioned above, the FSS 100 may be coupled to the conveyance device 106 in order to place the fire resistant substrate 102 above the object 1002 on fire. In the example of FIG. 10, the object 1002 on fire is a residential building. However, the object 1002 on fire may include any structure, tract of land, or other combustible object or material. In the case of a residential or other building, the extinguishing of the fire may include the deprivation of oxygen within the air of the building. Despite the existence of a significant amount of oxygen within the air inside the structure, it will be quickly consumed by the fire. Further, even if the fire resistant substrate 102 does not cover the structure entirely, the fire may likely consume all the oxygen within the air inside the structure. Further, in one example, the fire resistant substrate 102 may be placed on a portion of the structure that currently is on fire such as particular rooms or sections of the structure, and the deprivation of oxygen may extinguish the fire.

The FSS 100 may be brought into a position above the object 1002 on fire. The conveyance device 106 may be operated to place the fire resistant substrate 102 above at least a portion of the object 1002 on fire. In the transition depicted in FIG. 10, the coupling device 204 may be activated, and the fire resistant substrate 102 may be allowed to be set onto the object 1002. In one example, the operator of the conveyance device 106 may position the fire resistant substrate 102 above the object 1002 on fire such that the falling of the fire resistant substrate 102 does not damage the object 1002 and/or cause the object 1002 to collapse. Thus, in one example, the fire resistant substrate 102 is placed or set on the object 1002 rather than simply dropped. In instances where the object 1002 is a field, brush, or trees, is may be acceptable to allow the fire resistant substrate 102 to be dropped from relatively higher heights since damage to these types of objects is not as critical as damage that may otherwise occur to structures, automobiles or other manufactured objects. Shortly thereafter, the fire may be extinguished due to the consumption of the oxygen within the object 1002.

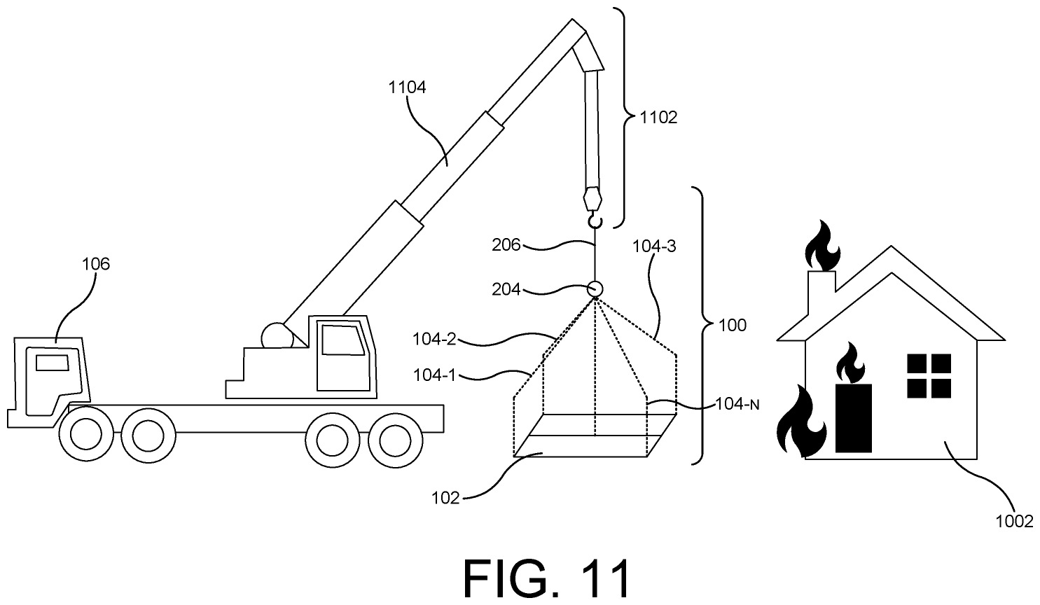

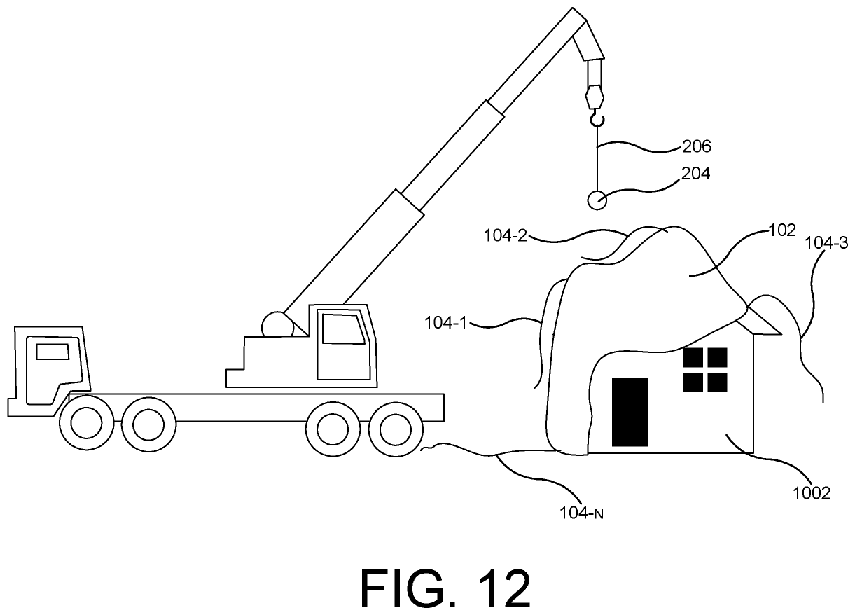

FIG. 11 illustrates a winch system 1102 associated with the FSS 100 of FIG. 2, according to an example of the principles described herein. FIG. 12 illustrates a method 1200 of deploying the FSS 100 of FIG. 1, according to an example of the principles described herein. As described herein, the conveyance device 106 may include a crane such as the crane depicted in FIGS. 11 and 12. The conveyance device 106 (e.g., crane) may include a winch system 1102 that may be used to couple the FSS 100 to the conveyance device 106. The winch system 1102 may be used to elevate the FSS 100 above the object 1002 on fire similar to the manner as described above in connection with the example of FIGS. 6-9. In one example, the conveyance device 106 (e.g., crane) may further include a boom 1104 or other extension device to allow the conveyance device 106 to remain at a relatively safer distance from the object 1002 on fire. This results in an increase in safety for operators, firefighting personnel, and bystanders.

Once the FSS 100 is hoisted above the object 1002 on fire, the conveyance device 106 may be operated to place the fire resistant substrate 102 above at least a portion of the object 1002 on fire. In the transition depicted between FIG. 11 and FIG. 12, the coupling device 204 may be activated, and the fire resistant substrate 102 may be allowed to fall onto the object 1002. Shortly thereafter, the fire may be extinguished due to the consumption of the oxygen within the object 1002.

In one example, a municipality, county, or state organization may create an aerial fire district comprising a squadron of pilots based at local airports. In this example, the squadron may work in conjunction with local, county, state, and/or federal governments including those governments' firefighting groups and organizations. The firefighting groups and organizations may include volunteer and/or professional firefighters, wildfire firefighters, and other types of firefighter professions. In this manner, individuals professionally trained to convey and deploy the FSS 100 and the fire resistant substrate 102 may be utilized by other firefighting groups to extinguish a myriad of types of fires.

In the examples described above, the fire resistant substrate 102 may be deployed onto any object on fire including, for example, a field of grass, trees, shrubs, etc. Further, the fire resistant substrate 102 may be deployed over automobiles or other equipment that may be on fire.

In one example, a number of straps may be used to contain the fire resistant substrate 102 of the FSS 100. In this example, the straps may surround the fire resistant substrate 102 during conveyance and may be released from the fire resistant substrate 102 for deployment. In one example, the straps may be released using wireless electronic fasteners configured to release from the fire resistant substrate 102 upon activate by a user. In one example, the straps may include Velcro and deployment of the fire resistant substrate 102 may be achieved by allowing the fire resistant substrate 102 to drop a predefined distance, stopping the decent of the fire resistant substrate 102 suddenly, and allowing the weight and acceleration of the fire resistant substrate 102 to rip the Velcro loose and release the fire resistant substrate 102 and allow the fire resistant substrate 102 to open much like a parachute with air acting as a drag to push the appendages 604, 704 from the center portion 602, 702.

During deployment of the examples of the fire resistant substrate 102 described herein, once the tether cables 104, straps, or other devices used to package the fire resistant substrate 102 for conveyance are released and the appendages 604, 704 are separated from the center portion 602, 702, the conveyance device 106 may assist in the decent of the fire resistant substrate 102 towards the object 1002 on fire in as flat of an orientation as possible. Once the fire resistant substrate 102 has reached the object 1002, firefighters located on the ground may assist in the placement of the fire resistant substrate 102 onto the object 1002 on fire.

In one example, the conveyance device 106 may not completely detach from the fire resistant substrate 102 during deployment. This may be so in order to allow the conveyance device 106 to clear the fire resistant substrate 102 from the object 1002 and allow firefighters to handle rescue operations within the structure or other area. For example, in the examples of FIGS. 4 and 5, one or more of the tether cables 104 may be retained by the cargo hook 402 while still allowing the fire resistant substrate 102 to be unfurled and placed on the object 1002. After the fire is extinguished, the conveyance device 106 may remove the fire resistant substrate 102 from the object 1002, place the fire resistant substrate 102 on a subsequent object 1002 on fire, and/or return to its point of origin (e.g., an airport) to pack or fold the fire resistant substrate 102 for a subsequent instance of an object 1002 catching on fire. In one example where the conveyance device 106 does not detach from the fire resistant substrate 102 during deployment, a cargo hook 402 may still be equipped on the conveyance device 106 in order to allow the fire resistant substrate 102 to be released from the conveyance device 106 in instances where control of the conveyance device 106 is at risk unless the fire resistant substrate 102 is released.

In one example, the fire resistant substrate 102 may include a fire resistant and/or heat resistant rope approximately 8 ft or longer attached to a number of corners of the appendages 604, 704. In one example, a break-away value of the ropes may have a value at approximately 200 lbs. which may be provided through the use of a number of fasteners that couple the ropes to the appendages 604, 704. These fasteners may be engineered to support up to approximately 200 lbs., and may be engineered to structurally fail at approximately 200 lbs. In one example, a number of leader lines with a maximum load value of approximately 200 lbs. In these examples, a firefighter on the ground may guide the fire resistant substrate 102 onto the object 1002 while still providing for a level of safety to the firefighter in instances where the conveyance device 106 moves abruptly. In those instances when the conveyance device 106 moves abruptly, the rope(s) may release under the weight of the firefighter and ensure that the firefighter is not hoisted into the air which may result in serious injury or death to the firefighters due to a subsequent and uncontrolled drop to the ground.

In one example, a number of portions of the fire resistant substrate 102 and/or the FSS 100 may be replaced and/or repaired throughout the lifespan of the FSS 100. In instances where an underfunded fire department or similar entity purchases the FSS 100, it may be beneficial to repair the FSS 100 and/or replace portions of the FSS 100 to avoid significant costs associated with replacing the entirety of the FSS 100. For example, the fire resistant substrate 102 or portions of the fire resistant substrate 102 may be repaired and/or replaced. Further, in one example, the integrated cable 108, one or more of the tether cables 104, the center cable 202, one or more of the layers of the fire resistant substrate 102, the elbows 300, the hub 500, the center portion 602, 702, one or more appendages 604, 704, one or more grommets 606, 706, and other elements described herein may be replaced and/or repaired. In one example, the engineering and manufacturing of the FSS 100 may be performed such that the FSS 100 and portions thereof may be replaced and/or repaired. For example, a segment of a tethering cable 104 may be removed and replaced throughout the lifespan of the FSS 100.

### CONCLUSION

The examples described herein provide a fire suppression system (FSS) including a conveyable fire resistant substrate. The fire resistant substrate may be used to safely extinguish objects on fire without requiring an individual to get close to the objects. The fire resistant substrate may be lifted above the object on fire using a conveyance device such as a helicopter or crane and placed onto the object on fire. The fire resistant substrate, once deployed, restricts the flow of oxygen or air into the presence of the object on fire, begins to cause the fire to consume all remaining oxygen under the fire resistant substrate, and extinguishes the fire.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A fire suppression system comprising:
a fire resistant substrate comprising:
a rectangular center portion;
at least one appendage coupled to the rectangular center portion;
a tether system to couple the fire resistant substrate to a conveyance device, the tether system comprising:
a cable; and
a coupling device coupling the cable to the fire resistant substrate.

2. The fire suppression system of claim 1, wherein the coupling device is a servo-activated coupling device to, when activated, decouple the fire resistant substrate from the cable used to couple the fire resistant substrate to a conveyance device.

3. The fire suppression system of claim 1, further comprising:
at least a first grommet defined in the rectangular center portion; and
at least a second grommet defined in the at least one appendage coupled to the rectangular center portion.

4. The fire suppression system of claim 3, wherein:
at least a portion of the cable is extended through at least one of the at least first grommet and the at least second grommet,
extension of the at least the portion of the cable through the at least one of the at least first grommet and the at least second grommet causes the fire resistant substrate to fold into a relatively smaller size, and
removal of the at least the portion of the cable from at least one of the at least first grommet and the at least second grommet causes the fire resistant substrate to unfurl from a folded state.

5. The fire suppression system of claim 4, wherein the coupling device comprises a cargo hook to, when activated:
releases the cable;
causes the cable to move out of engagement with the at least one of the at least first grommet and the at least second grommet; and
causes the fire resistant substrate to unfurl from the folded state.

6. The fire suppression system of claim 5, wherein the cargo hook is coupled to at least one of a helicopter and a crane.

7. The fire suppression system of claim 1, wherein the fire resistant substrate includes at least one of an outer shell, a moisture barrier, a thermal battier, a number of air-filled dead zones, fiber glasses, asbestos, polymers, nylon, polyester, Nomex, Kevlar, batten, or combinations thereof.

8. The fire suppression system of claim 1, wherein the cable includes at least one of fiber glasses, asbestos, polymers, nylon, polyester, Nomex, Kevlar, metal, metal alloys, or combinations thereof.

9. A fire suppression device comprising:
a fire resistant substrate including:
a rectangular center portion;
at least one appendage coupled to the rectangular center portion, the at least one appendage extending from a side of the rectangular center portion;
at least a first grommet defined in the rectangular center portion; and
at least a second grommet defined in the at least one appendage coupled to the rectangular center portion,
wherein the at least second grommet aligns with the at least first grommet when the at least one appendage is folded over on top of the rectangular center portion.

10. The fire suppression device of claim 9, wherein the fire resistant substrate comprises:
at least one layer of fire resistant material; and
at least one cable incorporated into the at least one layer of fire resistant material to reinforce the at least one layer of fire resistant material.

11. The fire suppression device of claim 10, wherein the at least one layer of fire resistant material comprises at least one of an outer shell, a moisture barrier, a thermal battier, a number of air-filled dead zones, fiber glasses, asbestos, polymers, nylon, polyester, Nomex, Kevlar, batten, or combinations thereof.

12. The fire suppression device of claim 11, wherein:
the at least one appendage comprises four appendages extending from four sides of the rectangular center portion, respectively,
the at least first grommet comprises a plurality of first grommets defined in the rectangular center portion,
the at least second grommet comprises a plurality of second grommets defined in the four appendages.

13. The fire suppression device of claim 12, wherein the plurality of second grommets defined in the four appendages align with the plurality of first grommets defined in the rectangular center portion when the four appendages are folded over on top of the rectangular center portion, the alignment of the plurality of first grommets and the plurality of second grommets allowing for a cable to be extended therethrough.

14. The fire suppression device of claim 9, further comprising a tether system to couple the fire resistant substrate to a conveyance device, the tether system comprising:
a cable; and
a coupling device coupling the cable to the fire resistant substrate.

15. A fire suppression system, comprising:
a conveyance device;
a fire resistant substrate comprising:
a rectangular center portion;
at least one appendage coupled to the rectangular center portion; and
a tether system to couple the fire resistant substrate to the conveyance device, the tether system comprising:
a cable; and
a coupling device coupling the cable to the fire resistant substrate.

16. The fire suppression system of claim 15, further comprising:
at least a first grommet defined in the rectangular center portion; and
at least a second grommet defined in the at least one appendage coupled to the rectangular center portion,
wherein the at least second grommet aligns with the at least first grommet when the at least one appendage is folded over on top of the rectangular center portion.

17. The fire suppression system of claim 15, wherein the conveyance device is a crane or a helicopter.

18. The fire suppression system of claim 15, wherein the coupling device is a servo-activated coupling device to, when activated, decouple the fire resistant substrate from the cable used to couple the fire resistant substrate to a conveyance device.

19. The fire suppression system of claim 16, wherein:
at least a portion of the cable is extended through at least one of the at least first grommet and the at least second grommet,
extension of the at least the portion of the cable through the at least one of the at least first grommet and the at least second grommet causes the fire resistant substrate to fold into a relatively smaller size, and
removal of the at least the portion of the cable from at least one of the at least first grommet and the at least second grommet causes the fire resistant substrate to unfurl from a folded state.

20. The fire suppression system of claim 19, wherein:
the coupling device comprises a cargo hook to, when activated:
releases the cable;
causes the cable to move out of engagement with the at least one of the at least first grommet and the at least second grommet; and
causes the fire resistant substrate to unfurl from the folded state.
